(19) United States
(12) Patent Application Publication
(10) Pub. No.: US 2006/0111078 A1
(43) Pub. Date: May 25, 2006

(54) Method of calculating fee for downloading data from WAP network

(75) Inventors: David Ho, Shanghai City (CN); Kai Tao Zhang, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei County (TW)

(21) Appl. No.: 11/198,186

(22) Filed: Aug. 8, 2005

(30) Foreign Application Priority Data
Nov. 24, 2004 (TW) 93136114

(51) Int. Cl. H04M 11/00

(52) U.S. Cl. 455/406

(57) ABSTRACT

The present invention provides a method of calculating fee for downloading data from the wireless application protocol (WAP) network, comprising the steps of: issuing a request for downloading data from a mobile communication device to a network server; recording a subscriber ID from the mobile communication device and a data ID, a fee status and a report status corresponding to the subscriber ID on the network server; issuing a download data package from the network server to the mobile communication device, and the download data package comprising the data ID and a count; recording the data ID and the count, a use count, a fee status request and a report status request corresponding to the data ID on the mobile communication device; and before the mobile communication device uses the download data, checking the fee status request, the report status request and if the use count is greater than the count, then deciding whether to prompt for a fee payment request, and permitting the use of the download data.

### FIELD OF THE INVENTION

The present invention relates to a method of calculating fee for downloading data from the network, and more particularly to an improved method of calculating fee for downloading multimedia data from the wireless application protocol (WAP) by means of a mobile communication device.

### BACKGROUND OF THE INVENTION

With the continuous development of wireless network technology, it has become common to use mobile communication devices, such as mobile phones or personal data assistants (PDA) capable of engaging in wireless communication, or other mobile communication products as hardware application platforms to download multimedia data such as ring tones, pictures, and games via wireless network as a transmission path. Moreover, the development of J2ME technology further facilitates such applications.

When the interaction between mobile subscribers and Internet service providers (ISPs) becomes frequent, a new issue occurs to the mobile subscribers: that is how to provide a reliable fee calculation method in a network environment. Due to the unreliability of wireless network connectivity, a lot of unreasonable issues are inherent in traditional fee calculation methods; moreover, mobile subscribers often complain about their failure in downloading data for which they have already paid because of network issues. Furthermore, mobile subscribers also have the problem with the download data because such download data fail to be supported by wireless terminal devices, so that the mobile subscribers are not able to use such download data.

As the above issues are inherent in the existing applications, mobile subscribers develop extremely negative attitudes toward the development and operations of wireless network. The present invention is intended to assure that mobile subscribers can enjoy the fun of using the downloaded data after they have made the payment and the ISP can obtain reasonable reward.

### SUMMARY OF THE INVENTION

Due to the conventional technology, mobile subscribers regard the development and operations of wireless network with negativity and unreliability. Taking both the right entitled to mobile subscribers after they have made the payment and the reward of ISPs into account, the present invention provides a method of calculating fee for downloading data from the network that can assure the right entitled to the mobile subscribers after they have made the payment and also enables the ISP to easily manage the fee calculation for downloading data.

To overcome the abovementioned shortcomings, it is the primary object of the present invention to provide a method of calculating fee for downloading data from the network, with the hope of achieving the fee calculation for downloading data between an ISP end and a mobile subscriber end.

It is another object of the present invention to provide a method of calculating fee for downloading data from the network, with the hope of achieving the downloading of paid data by a WAP mobile phone from a network server via the WAP network.

To achieve the aforementioned objects of the present invention, the present invention provides a method of calculating fee for downloading data from the network, comprising the steps of:

recording a subscriber ID and a data ID, a fee status and a report status corresponding to the subscriber ID on an ISP end;

recording the data ID and a count, a use count, a fee status request and a report status request corresponding to the data ID on a mobile subscriber end comprising the subscriber ID; and

before the mobile subscriber end uses download data, checking the fee status request, the report status request and if the use count is greater than the count, then deciding whether to prompt for a fee payment request, and permitting the use of download data.

Wherein the mobile subscriber end further comprises: recording a price, a fee URL (Universal Resource Locator), and a report URL of the download data corresponding to the data ID.

Wherein the mobile subscriber end further comprises: checking the fee status request, the report status request and if the use count is greater than the count, and then deciding whether to prompt for a fee payment request and a price for the download data.

Wherein the mobile subscriber end further comprises: checking if the fee status request is “not paid” and the report status request is also “not reported,” and then deciding to prompt for a fee payment request and a price for the download data on the mobile subscriber end.

Wherein the mobile subscriber end further comprises: checking if the fee status request is “not paid”, and if the use count is smaller than or equal to the count, and then permitting the mobile subscriber end to use the download data.

Wherein the mobile subscriber end further comprises: checking if the fee status request is “not paid” and the report status request is also “not reported” and if the use count is greater than the count, then deciding to prompt for a fee payment request and a price on the mobile subscriber end, and forbidding the mobile subscriber end to use the download data.

To achieve the aforementioned objects of the present invention, the present invention provides a method of calculating fee for downloading data from the network operated on a mobile communication device, comprising the steps of:

issuing a request to a network server for downloading data,

receiving a download data package issued from the network server, and the download data package comprises the data ID and a count;

recording the data ID and the count, a use count, a fee status request and a report status request corresponding to the data ID; and

prior to the use of the download data, checking the fee status request, the report status request, and if the use count is greater than the count, then deciding whether to prompt for the fee payment request, and permitting the use of the download data.

Wherein the mobile communication device further comprises: checking the fee status request, the report status request and if the use count is greater than the count, and then deciding whether to prompt for a fee payment request and a price for the download data.

Wherein the mobile communication device further comprises: checking if the fee status request is “not paid” and the report status request is also “not reported” and then deciding to prompt for a fee payment request and a price for the download data.

Wherein the mobile communication device further comprises: checking if the fee status request is “not paid”, and if the use count is smaller than or equal to the count, and then permitting the use of the download data.

Wherein the mobile communication device further comprises: checking if the fee status request is “not paid” and the report status request is also “not reported”, and the use count is greater than the count, then deciding to prompt for the fee payment request and a price for the download data, and forbidding the use of the download data.

### BRIEF DESCIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a system structural diagram of a method of calculating fee for downloading data from the network disclosed in the present invention.

FIG. 2 shows an information flowchart of a method of calculating fee for downloading data from the network disclosed in the present invention.

### DETAILED DESCRIPTION OF THE PREFERRED EMBODIMENTS

While the invention has been described by way of examples and in terms of preferred embodiments, it is to be understood that the invention is not limited thereto. To the contrary, it is intended to carry out various modifications and similar arrangements and procedures, and the scope of the appended claims therefore should be accorded the broadest interpretation so as to encompass all such modifications and similar arrangements and procedures.

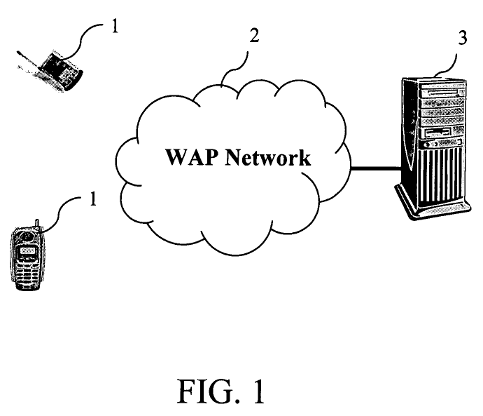

First of all, according to FIG. 1, which shows a system structural diagram of the present invention to realize a method of calculating fee for downloading data from the network. The method of calculating fee for downloading data from the network disclosed in the present invention is intended to achieve the fee calculation for downloading data between a network server 3 of an ISP end and a mobile communication device of a mobile subscriber end, and the network server 3 and a mobile communication device transmit information via a wireless network.

According to the embodiment shown in FIG. 1, the WAP mobile phone 1 is taken as an example of the mobile communication device, and the WAP network 2 is taken as an example of the wireless network. The WAP mobile phone 1 at the mobile subscriber end is connected to the network server 3 at the ISP end via the wireless application protocol, and moreover, the network server 3 provides the WAP mobile phone 1 with paid multimedia such as data, ring tones, pictures, and games available for downloading. Then the mobile subscriber selects and decides the multimedia data to be downloaded through the operations of the man-machine interface (such as “button”) of the WAP mobile phone 1, so that the WAP mobile phone 1 receives the download data, issues a fee status request to the network server 3 prior to the use of the download data, and then records the fee status. Moreover, while using the download data, the WAP mobile phone 1 will also issue a report status request to the network server 3, after having confirmed the fee payment, so as to assure the mobile subscriber's right of using the download data. In this way, this will prevent the WAP mobile phone 1 from deleting the record of using the download data without receiving a response from the network server 3; otherwise, the mobile subscriber has the problem of having made the payment without the right of using the download data.

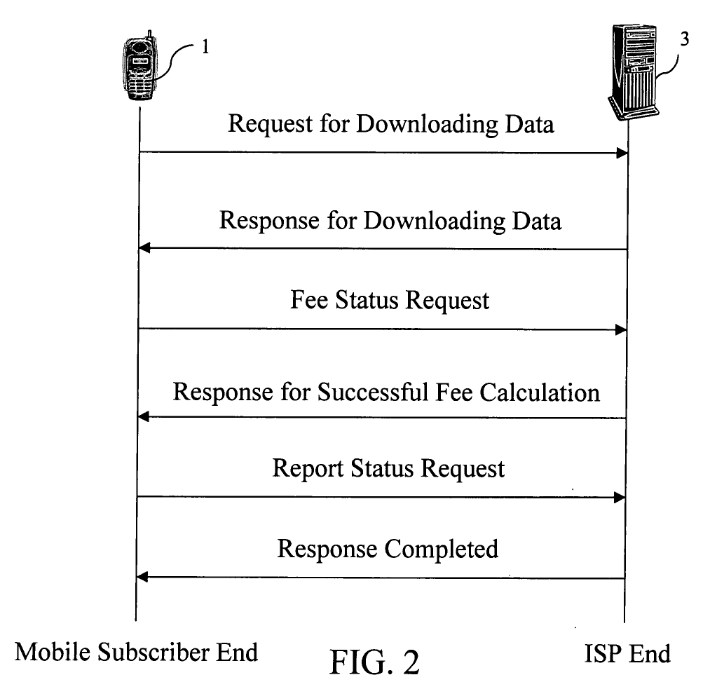

Please refer to FIG. 2, which is an information flowchart of a method of calculating fee for downloading data from the network disclosed in the present invention. In a more preferred embodiment, taking the WAP network as an example of an information transmission path, the method of calculating fee for downloading data from the WAP network disclosed in the present invention comprises the step of issuing a request for downloading data from the WAP mobile phone 1 at the mobile subscriber end to the network server 3 at the ISP end. Then the network server 3 responds to the request of the WAP mobile phone 1 for downloading data by generating related records in a fee database (not shown in the figure), as shown in the following Table 1.

TABLE 1

| | Subscriber ID | Data ID | Fee Status | Report Status | . . . |
|---|---|---|---|---|---|
| 1. | Oooooooo | ### | F | F | . . . |
| 2. | Xxxxxxxx | *** | T | F | . . . |

Table 1 demonstratively refers to the downloaded data table stored in the fee database. The downloaded data table at least comprises the following columns: subscriber ID, data ID, fee status, and report status, and another column can comprise the price required for paying the download data corresponding to the data ID.

In Table 1, the subscriber ID is the only identification number used to record the mobile subscriber. Taking the WAP mobile phone 1 or mobile communication device comprising the Subscriber Identity Module Card (SIM card) as an example, the subscriber ID is the International Mobile Station Equipment Identity (IMEI) code of the SIM card; the data ID is the code of the multimedia data downloaded by the WAP mobile phone 1 or a mobile communication device to record the corresponding subscriber ID; the fee status is to record whether the WAP mobile phone 1 or the mobile communication device corresponding to the subscriber ID has issued a request for fee calculation; the report status is to record whether the WAP mobile phone 1 or the mobile communication device corresponding to the subscriber ID has issued a request for report.

When the network server 3 responds to the request of the WAP mobile phone 1 for downloading data, it will generate related records in a table as shown in Table 1, wherein the initial value of the fee status and the report status is F (False) respectively, which means that the WAP mobile phone 1 or the mobile communication device corresponding to the subscriber ID has already downloaded the multimedia data of the data ID, but fee has not been paid and reported. After the network server 3 has received a fee status request or a report status request issued by the WAP mobile phone 1, it changes the “F” value to “T” (True) value in the “fee status” column and the “report status” column respectively.

The network server 3 responds to the request issued by the WAP mobile phone 1 for downloading data by downloading the data and issuing a download data package to the WAP mobile phone 1; the package structure of the download data is as follows:

Package Structure
{

fee URL;
fee ULR length;
report URL;
report ULR length;
count;

data ID;

download data;
price;
. . .

}

wherein fee URL is the fee URL to which the WAP mobile phone 1 issues a fee request; fee URL length is the length of the fee URL; report URL is the report URL to which the WAP mobile phone 1 issues a report request; report URL length is the length of the report URL; count is the count of allowing the WAP mobile phone 1 to use the download data free on a trial basis; data ID is the code for downloading data; download data is the downloaded multimedia data such as ring tones, pictures, and games; price is the price required for the downloaded multimedia data.

After the WAP mobile phone 1 has received the download data package, it will then receive the following information related to the download data, including fee URL; fee URL length; report URL; report URL length; count; data ID; download data; etc. Hence, the WAP mobile phone 1 generates records corresponding to the related information about the download data, as shown in Table 2:

TABLE 2

| | | | | | Fee | Report | | |
|---|---|---|---|---|---|---|---|---|
| | Data | Fee | Report | | Status | Status | Use | |
| | ID | URL | URL | Count | Request | Request | Count | . . . |
| 1 | ### | | | | F | F | | . . . |
| 2 | *** | | | | T | F | | . . . |
| 3 | $$$ | | | | T | T | | . . . |

Table 2 demonstratively refers to the data-use recording table stored in the WAP mobile phone 1. The data-use recording table at least comprises the following columns: data ID, fee URL, report URL, count, fee status request, report status request, and use count, and another column can comprise the price required for paying the download data corresponding to the data ID.

The mobile phone 1 uses the related information of the download data generated in the data-use recording table, wherein the initial value of the fee status request, the report status request, and the use count is F (False), F (False), and 0 respectively. The initial “F” value of the fee status request means that the WAP mobile phone 1 or the mobile communication device has not issued a fee status request, and the fee status will only be changed to “T” until the WAP mobile phone 1 or the mobile communication device has issued a fee status request; the initial “F” value of the report status request means that the WAP mobile phone 1 or the mobile communication device has not issued a report status request, and the fee status will only be changed to “T” until the WAP mobile phone 1 or the mobile communication device has issued a report status request; the initial “0” value of the use count means that the WAP mobile phone 1 or the mobile communication device has not used the download data, and the value of the use count will be increased by one whenever the WAP mobile phone 1 or the mobile communication device uses the download data.

In a more preferred embodiment of the present invention, when the mobile subscriber operates the WAP mobile phone 1 to use the download data, the WAP mobile phone 1 will check if there is the right of using the download data. Then the WAP mobile phone 1 checks the data-use recording table, and if the report status request is T (that is “reported”), the WAP mobile phone 1 permits the mobile subscriber to use the download data; on the other hand, when the WAP mobile phone 1 checks the data-use recording table, and if the report status request is F (that is “not reported”), but the fee status request is T (that is “paid”),the WAP mobile phone 1 permits the mobile subscriber to use the download data; however, the WAP mobile phone 1 is required to issue a report status request to the report URL, and it will only change the report status request to T (that is “reported”) until the WAP mobile phone 1 receives the report from the network server 3.

The WAP mobile phone 1 checks the data-use recording table, and if the report status request is F (that is “not reported”) and the fee status request is also F (that is “not paid”), then the WAP mobile phone 1 will prompt for the fee payment request and the price for the fee payment; moreover, only when the WAP mobile phone 1 checks that the use count has not exceeded the limit of count, the WAP mobile phone 1 will permit the mobile subscriber to use the download data; otherwise, if the use count has exceeded the limit of count, the WAP mobile phone 1 will forbid the mobile subscriber to use the download data.

When the mobile subscriber decides to pay the fee prompted by the WAP mobile phone 1, the mobile subscriber operates the input interface of the WAP mobile phone 1 and then issues a fee status request to the fee URL.

Consequently, after the WAP mobile phone 1 has received the download data, three statuses may occur as follows:
(1) “Not Paid” status (the fee status request is F): The WAP mobile phone 1 a trial basis, and if the use count exceeds the limit of count, the mobile subscriber can only select “Agree to Pay the download data” or “Delete the download data” when prompted by the WAP mobile phone 1 for fee payment request, and has no right of using the download data.
(2) “Paid” status (the fee status request is T): The WAP mobile phone 1 grants the mobile subscriber the full right of using the download data, but the WAP mobile phone 1 is required to issue a report status request to the network server 3 to show that the WAP mobile phone 1 has already received a response for fee payment; because if the WAP mobile phone 1 has not issued a report status request to the network server 3, and when the network server 3 has completed the fee payment, and the WAP mobile phone 1 has not received the response for fee payment, the WAP mobile phone 1 will forbid the mobile subscriber to use the download data, which will create a situation in which the network server 3 has already calculated fee for the mobile subscriber, but the mobile subscriber is not granted with the right of using the download data.
(3) “Fee Calculation Completed” status (the fee status request is T and the report status request is T): The WAP mobile phone 1 grants the mobile subscriber the full right of using the download data.

While the invention has been described by way of examples and in terms of preferred embodiments, it is to be understood by those who are familiar with the prior art that the invention is not limited thereto. To the contrary, it is intended to carry out various modifications and similar arrangements and procedures, and the scope of the appended claims therefore should be accorded the broadest interpretation so as to encompass all such modifications and similar arrangements and procedures.

What is claimed is:

1. A method of calculating fee for downloading data from the network, comprising:
recording a subscriber ID and a data ID, a fee status and a report status corresponding to said subscriber ID on an ISP end;
recording said data ID and a count, a use count, a fee status request and a report status request corresponding to said data ID on a mobile subscriber end comprising said subscriber ID; and
before said mobile subscriber end uses download data, checking said fee status request, said report status request and if said use count is greater than said count, then deciding whether to prompt for a fee payment request and permitting the use of said download data.

2. The method of calculating fee as claimed in claim 1, further comprising the step of recording a price corresponding to said data ID, a fee URL, and a report URL on said mobile subscriber end.

3. The method of calculating fee as claimed in claim 2, further comprising the step of checking said fee status request, said report status request and if said use count is greater than said count, and then deciding whether to prompt for said fee payment request and said price.

4. The method of calculating fee as claimed in claim 1, further comprising the step of checking if said fee status request is “not paid” and said report status request is “not reported”, and then deciding to prompt for said fee payment request and a price on said mobile subscriber end.

5. The method of calculating fee as claimed in claim 1, further comprising the step of checking if said fee status request is “not paid” and said use count is smaller than or equal to said count, and then permitting said mobile subscriber end to use said download data.

6. The method of calculating fee as claimed in claim 1, further comprising the step of checking if said fee status request is “not paid” and said report status request is “not reported” and said use count is greater than said count, then deciding to prompt for said fee payment request and a price on said mobile subscriber end, and forbidding said mobile subscriber end to use said download data.

7. The method of calculating fee as claimed in claim 1, further comprising the step of checking said report status request is “reported”, and then permitting said mobile subscriber end to use said download data.

8. The method of calculating fee as claimed in claim 1, further comprising the step of checking if said report status request is “not reported”, but said fee status request is “paid”, and then permitting said mobile subscriber end to use said download data, and moreover, issuing a report status request from said mobile subscriber end.

9. The method of calculating fee as claimed in claim 2, further comprising the step of checking if said fee status request is “not paid”, and then deciding to issue a fee status request to said fee URL from said mobile subscriber end.

10. The method of calculating fee as claimed in claim 9, further comprising the step of recording the fee status request of said ISP end as “paid” and then issuing a response to said mobile subscriber end for successful fee calculation, when said ISP end has received said fee status request issued by said mobile subscriber end.

11. The method of calculating fee as claimed in claim 10, further comprising the step of recording said fee status request of said mobile subscriber end as “paid”, when said mobile subscriber end has received the response for successful fee calculation from said ISP end.

12. The method of calculating fee as claimed in claim 2, further comprising the step of checking if said report status request is “not reported”, but said fee status request is “paid”, and then deciding to issue a report status request to said report URL from said mobile subscriber end.

13. The method of calculating fee as claimed in claim 12, further comprising the step of recording the report status request of said ISP end as “reported” and then issuing a response to said mobile subscriber end for successful reporting, when said ISP end has received said report request issued by said mobile subscriber end.

14. The method of calculating fee as claimed in claim 13, further comprising the step of recording said report status request of said mobile subscriber end as “reported”, when said mobile subscriber end has received the response for successful reporting from said ISP end.

15. The method of calculating fee as claimed in claim 1, further comprising: said download data are ring tones or pictures or games.

16. A method of calculating fee for downloading data from the network comprising the steps of:
issuing a request from a mobile communication device to a network server for downloading data;
recording a subscriber ID of said mobile communication device and a data ID, a fee status and a report status corresponding to said subscriber ID on said network server;
issuing a download data package from said network server to said mobile communication device, said download data package comprising said data ID and a count;
recording said data ID and said count, a use count, a fee status request and a report status request corresponding to said data ID on said mobile communication device; and
before said mobile communication device uses said download data, checking said fee status request, said report status request and if said use count are greater than said count, then deciding whether to prompt for said fee status request, and permitting the use of said download data.

17. The method of calculating fee as claimed in claim 16, further comprising the step of recording a price, a fee URL and a report URL corresponding to said data ID.

18. The method of calculating fee as claimed in claim 17, further comprising the step of checking said fee status request, said report status request and if said use count is greater than said count, and then deciding whether to prompt for said fee request and said price.

19. The method of calculating fee as claimed in claim 16, further comprising the step of checking if said fee status request is “not paid” and said report status request is also “not reported”, and then deciding to prompt for said fee request and a price on said mobile communication device.

20. The method of calculating fee as claimed in claim 16, further comprising the step of checking if said fee status request is “not paid” and said use count is smaller than or equal to said count, and then permitting said mobile communication device to use said download data.

21. The method of calculating fee as claimed in claim 16, further comprising the step of checking if said fee status request is “not paid” and said report status request is “not reported”, and said use count is greater than said count, then deciding to prompt for said fee request and a price on said mobile communication device, and forbidding said mobile communication device to use said download data.

22. The method of calculating fee as claimed in claim 16, further comprising the step of checking said report request is “reported”, and then permitting said mobile communication device to use said download data.

23. The method of calculating fee as claimed in claim 16, further comprising the step of checking if said report status request is “not reported”, but said fee request is “paid”, then permitting said mobile communication device to use said download data, and moreover, issuing a report status request from said mobile communication device.

24. The method of calculating fee as claimed in claim 17, further comprising the step of checking if said fee status request is “not paid”, and then deciding to issue a fee status request to said fee URL from said mobile communication device.

25. The method of calculating fee as claimed in claim 24, further comprising the step of recording the fee status of said network server as “paid” and then issuing a response to said mobile communication device for successful fee calculation, when said network server has received said fee request issued by said mobile communication device.

26. The method of calculating fee as claimed in claim 25, further comprising the step of recording said fee status request of said mobile communication device as “paid”, when said mobile communication device has received the response for successful fee calculation from said network server.

27. The method of calculating fee as claimed in claim 17, further comprising the step of checking if said report status request is “not reported”, but said fee status request is “paid”, and then deciding to issue a report status request to said report URL from said mobile communication device.

28. The method of calculating fee as claimed in claim 27, further comprising the step of recording the report status of said network server as “reported” and then issuing a response to said mobile communication device for successful reporting, when said network server has received said report status request issued by said mobile communication device.

29. The method of calculating fee as claimed in claim 28, further comprising the step of recording said report status request of said mobile communication device as “reported”, when said mobile communication device has received the message for successful reporting from said network server.

30. The method of calculating fee as claimed in claim 16, further comprising: said download data are ring tones or pictures or games.

31. A method of calculating fee for downloading data from the network operated on a mobile communication device, comprising the steps of:
issuing a request to a network server for downloading data,
receiving a download data package issued from said network server, said download data package comprising said data ID and a count;
recording said data ID and said count, a use count, a fee status request and a report status request corresponding to said data ID, and
prior to the use of said download data, checking said fee status request, said report status request and if said use count is greater than said count, then deciding whether to prompt for said fee request, and permitting the use of said download data.

32. The method of calculating fee as claimed in claim 31, further comprising the step of recording a price, a fee URL, and a report URL comprised in said download data package.

33. The method of calculating fee as claimed in claim 32, further comprising the step of checking said fee status request, said report status request and if said use count is greater than said count, and then deciding whether to prompt for said fee request and said price.

34. The method of calculating fee as claimed in claim 31, further comprising the step of checking if said fee status request is “not paid” and said report status request is also “not reported”, and then deciding to prompt for said fee request and a price.

35. The method of calculating fee as claimed in claim 31, further comprising the step of checking if said fee status request is “not paid” and said use count is smaller than or equal to said count, and then permitting the use of said download data.

36. The method of calculating fee as claimed in claim 31, further comprising the step of checking if said fee status request is “not paid” and said report status request is “not reported” and said use count is greater than said count, then deciding to prompt for said fee request and a price, and forbidding the use of said download data.

37. The method of calculating fee as claimed in claim 31, further comprising the step of checking if said report status request is “reported”, and then permitting said mobile communication device to use said download data.

38. The method of calculating fee as claimed in claim 31, further comprising the step of checking if said report status request is “not reported”, but said fee status request is “paid”, and then permitting the use of said download data, and moreover, issuing a report status request.

39. The method of calculating fee as claimed in claim 32, further comprising the step of checking if said fee status request is “not paid”, and then deciding to issue a fee status request to said fee URL from said mobile communication device.
